(19) United States
(12) Patent Application Publication
(10) Pub. No.: US 2019/0303141 A1
(43) Pub. Date: Oct. 3, 2019

(54) Syntax Based Source Code Search

(71) Applicant: Elasticsearch B.V., Mountain View, CA (US)

(72) Inventors: Chongzhe Li, Fremont, CA (US); Fuyao Zhao, Sunnyvale, CA (US); Mengwei Ding, Sunnyvale, CA (US)

(21) Appl. No.: 16/286,269

(22) Filed: Feb. 26, 2019

Related U.S. Application Data
(60) Provisional application No. 62/650,018, filed on Mar. 29, 2018.

(51) Int. Cl. G06F 8/75; G06F 8/41; G06F 16/9038; G06F 16/901

(52) U.S. Cl. CPC G06F 8/75; G06F 16/9024; G06F 16/9038; G06F 8/427

(57) ABSTRACT

The methods and corresponding systems may include retrieving one or more Abstract Syntax Trees (ASTs) associated with source code. The ASTs may describe syntax structures of the source code. The source code may comprise a collection of computer instructions including code symbols and code snippets. The source code may comprise a collection of files. A knowledge graph may be generated based on the one or more ASTs. The knowledge graph may describe relationships between occurrences of the code symbols or the code snippets contained in the source code. Importance levels, representing importance scores, for occurrences of the code symbol or the code snippets may be determined based on the knowledge graph. In response to a code search query, rankings may be determined based on importance levels that are determined in real time, or may be based on importance levels previously determined, using the present technology, for the source code.

### CROSS-REFERENCE TO RELATED APPLICATION(S)

This application claims the benefit of U.S. Provisional Patent Application No. 62/650,018, filed Mar. 29, 2018, which is incorporated by reference in its entirety herein.

### FIELD

The present technology pertains in general to source code search, in particular, to syntax based source code search.

### BACKGROUND

The approaches described in this section could be pursued but are not necessarily approaches that have previously been conceived or pursued. Therefore, unless otherwise indicated, it should not be assumed that any of the approaches described in this section qualify as prior art merely by virtue of their inclusion in this section.

Source code is a collection of computer instructions written using a programming language for implementing certain function(s). The source code may also include comment in text form. It is desirable to enable a user to search source code. Conventional web-based code search tools are designed to help users quickly find certain text in the source code. Various code search tools include algorithms that treat source code as plain text. These plain text based algorithms may include term frequency-inverse document frequency (tf-idf) based algorithms to rank the code search results. Such plain text based code search algorithms tend to rank source code based on the number of times a search query appears in the text in the source code.

In contrast, software developers, the most important users of the code search tools, are more likely to be looking instead for a definition or other important syntax structures in the source code represented by the search query. For example, a software developer typically inputs a query, e.g., a word “string” into a code search tool in order to seek relevant source code of a class named “string” in certain programming languages, e.g. JAVA, C++, PYTHON, etc., to facilitate the user's programming of the user's own class. The goal of the search would be to find a definition of the particular class (e.g., class named “string”) rather than just finding other occurrences of the word “class” (e.g., occurrences in comments in the source code or otherwise not being the definition of the class). Thus, for users such as software developers, the number of times a search query appears frequently does not reflect the syntactic importance that is desired by the user initiating the search. Consequently, other source code search tools provide rankings of code search results that are frequently not helpful to the user. As a result, software developers often spend an inordinate amount of time to find the source code they need. It is thus desirable to have a more useful code search method SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

One aspect of the present disclosure is directed to a method and system that takes the syntax of the source code into account as part of ranking results in response to a code search query from a user. Various embodiments of the present technology are directed to determining an importance level for an occurrence of a code symbol contained in source code such that, based on the importance level for each occurrence, results in response to a code search query from a user may be ranked.

In various embodiments, the method for the present technology comprises retrieving one or more representations of a syntax structure syntax structure associated with source code, the representations of the syntax structure describing syntax knowledge of the source code. The source code may comprise a collection of computer instructions using a programming language. The source code can contain code symbols. The method may further include generating a knowledge graph based on the one or more representations of the syntax structure, the knowledge graph describing relationships between occurrences of code symbols or code snippets contained in the source code. In various embodiments, the method further includes determining an importance level for an occurrence of a code symbol contained in the source code based on the knowledge graph, such that, based on the importance level for each occurrence, results in response to a code search query from a user are ranked for presentation to the user.

In various embodiments, the one or more representations of the syntax structure of the source code are Abstract Syntax Trees (ASTs).

The source code may comprise a collection of one or more files. The source code can include one or more portions referred to as snippets.

The importance level for an occurrence of a code symbol or code snippet may describe how important the occurrence of the code symbol or code snippet is: with respect to each occurrence's relationship with other occurrences of the code symbol or the code snippet contained in the source code, or with respect to each occurrence's relationship with other code symbols or other code snippets contained in the source code.

In some embodiments, generating a knowledge graph based on the one or more ASTs comprises relating two ASTs by matching a unique node name contained in both of the ASTs. In some embodiments, generating a knowledge graph based on the one or more ASTs may comprise obtaining a plurality of nodes from the one or more ASTs, the nodes representing the occurrences of code symbols or code snippets contained in the source code; obtaining data describing the relationships between the plurality of nodes from the one or more ASTs; and generating the knowledge graph using the plurality of nodes and the data describing the relationships between the plurality of nodes.

In various embodiments, the method comprises, in response to receiving a search query from a user to search for a code symbol or a code snippet in source code, determining whether the importance levels associated with the search query have already been determined for the source code, and if the importance levels associated with the search query have already been determined for the source code, retrieving the already determined importance levels; obtaining importance scores represented by the already determined importance levels; and ranking the occurrences of the code symbol based on the importance scores. The already determined importance levels may be represented by importance scores and stored in a database. In some embodiments, if the importance levels associated with the search query have not been already been determined, the importance levels are determined in real time.

In some embodiments, another aspect of the present disclosure is directed to a system for ranking code search results. The system may comprise one or more processors; and a memory storing instructions that, when executed by the one or more processors, cause the system to perform the following: receiving a search query from a user to search for a code symbol or a code snippet; obtaining source code containing occurrences of the code symbol or the code snippet; determining importance scores for occurrences of the code symbol or the code snippet contained in the source code; ranking the occurrences of the code symbol or the code snippet based on the importance scores; and causing the ranked occurrence of the code symbol or the code snippet to be presented to a user.

Benefits of the methods and systems disclosed include, but are not limited to, determining importance levels for occurrences of search queries, whether they are a code symbol or a code snippet, based on syntax of the source code containing the search queries, and facilitating code search tools to rank code search results more accurately matching the desires of potential users. Accordingly, a drastically improved ranking of the search results may be obtained. By using the search tool based on the importance level of code, users may find their desired source code much faster than by using a traditional code search tool.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention. It is to be understood that the foregoing general description and the following detailed description are exemplary and explanatory only, and are not restrictive of the invention, as claimed.

### BRIEF DESCRIPTION OF THE DRAWINGS

Embodiments are illustrated by way of example, and not by limitation, in the figures of the accompanying drawings, in which like references indicate similar elements and in which:

FIG. 1 illustrates an example environment for determining importance levels for occurrences of a code symbol or a code snippet in source code, and for ranking code search results based on the importance levels, according to various embodiments.

FIG. 2A illustrates an example of source code, according to various embodiments.

FIG. 2B illustrates a block diagram for an example of a knowledge graph, according to various embodiments.

FIG. 2C illustrates another example of source code, according to various embodiments.

FIG. 2D illustrates a block diagram for another example of a knowledge graph, according to various embodiments.

FIG. 3 illustrates a flow chart of an example method for determining an importance level for an occurrence of a code symbol such that, based on the importance level for each occurrence, results in response to a code search query from a user are ranked for presentation to the user, according to various embodiments.

FIG. 4 illustrates a flow chart of an example method for determining importance scores for nodes in a knowledge graph, according to various embodiments.

FIG. 5 illustrates a flow chart of an example method for ranking occurrences of a code symbol, according to various embodiments.

FIG. 6 illustrates a flow chart of an example method for ranking occurrences of a code snippet, according to various embodiments.

FIG. 7 illustrates a block diagram of an example computer system in which any of the embodiments described herein may be implemented.

### DETAILED DESCRIPTION

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated. The terminology used herein is for the purpose of describing particular embodiments only and is not intended to be limiting of the technology. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof. It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

The present disclosure is related to various embodiments of systems and methods for, using on the syntax of the source code, ranking results in response to a code search query from a user

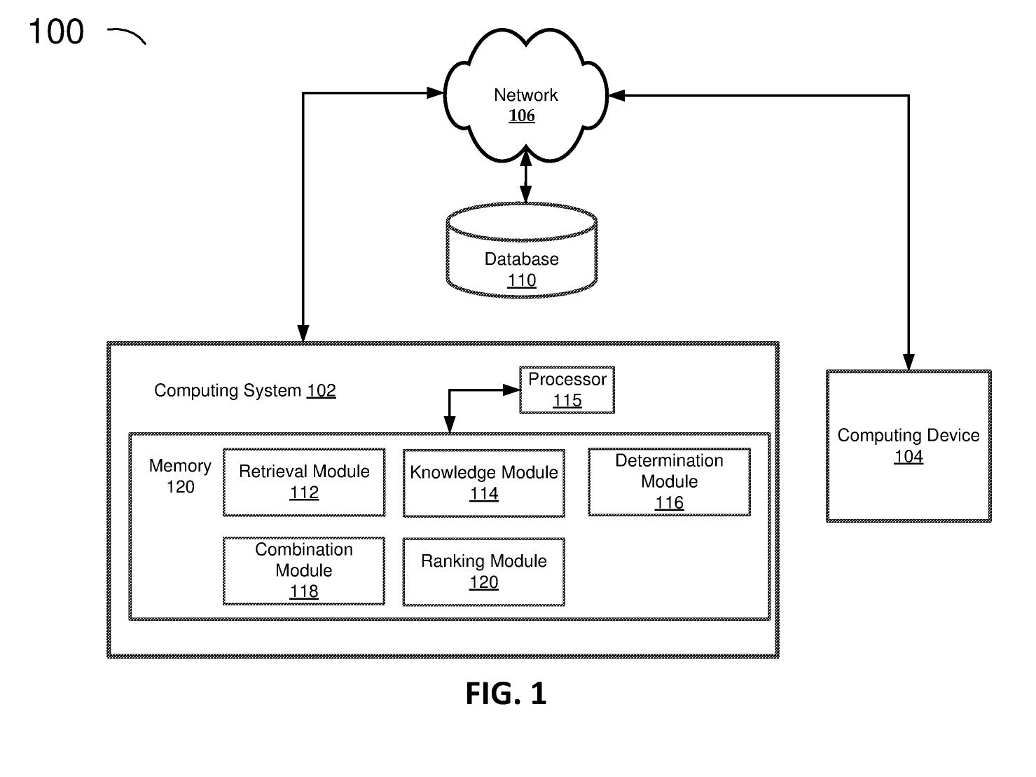

FIG. 1 illustrates an example environment 100 for determining importance levels for occurrences of a code symbol or a code snippet in source code, and for ranking code search results based on the importance levels for occurrences of the code symbol or code snippet, in accordance with various embodiments. The source code source code comprises a collection of computer instructions using a programming language. In various embodiments, the collection for the source code includes code symbols and can include or more code snippets. The source code can comprise a collection of one or more files.

The example environment 100 may include a computing system 102 (e.g., a server), a computing device 104 (e.g., a client device, desktop, laptop, smartphone, tablet, mobile device), and a database 110. The computing system 102 and the computing device 104 may include one or more processors and memory (e.g., permanent memory, temporary memory). The processor(s) may be configured to perform various operations by interpreting machine-readable instructions stored in the memory. The computing system 102 and the computing device 104 may include other computing resources and/or have access (e.g., via one or more connections/networks) to other computing resources.

Although the computing system 102, the computing device 104, and the database 110 are shown in FIG. 1 as single entities, this is merely for ease of reference and is not meant to be limiting. One or more components or functionalities of the computing system 102, the computing device 104, and/or the database 110 described herein may be implemented in a single computing device or multiple computing devices. For example, one or more components or functionalities of the computing system 102 may be implemented in the computing device 104 and/or distributed across multiple computing devices.

The computing device 104 and/or another computing device coupled to the computing device 104 may receive code search queries from users and convey the search queries to the other components in the environment 100. For example, when a user submits a search query from the computing device 104 to search for a code symbol or a code snippet, the computing system 102 or another computing system (not shown in FIG. 1) may obtain source code containing occurrences of the search query. The source code may comprise a collection of one or more source code files and can include one or more of the code symbols and comments. The computing system 102 or the other computing system may obtain source code containing occurrences of the search query by using web crawlers or other types of searching technologies. In some embodiments, if the other computing system obtains the source code containing occurrences of the search query, it may be conveyed to the computing system 102 for determining importance levels of the results and for ranking the results. The computing system 102 may send the ranked source code results to the computing device 104 via the network 106 for providing the results to the users.

In some embodiments, part or all of the functionalities of the computing system 102, such as determining associated source code based on search queries, determining importance levels, and ranking code search results, may be implemented by the computing device 104. For example, the computing device 104 may receive a submission of a search query from a user, and determine the associated source code based on the search query. The computing device 104 may also determine importance levels associated with occurrences of the search query and rank code search results based on the importance levels. In some embodiments, the computing device 104 may determine the importance levels for occurrences of the search query locally.

Alternatively, the computing device 104 may determine the importance levels for occurrences of the search query from other components of the environment 100, e.g., from the computing system 102, or the database 110 if the importance levels have been stored, e.g., in the database 110.

In some embodiments, the determination of importance levels for code search results may be implemented in real time as described above. That is, in response to a user submitting a search query, the computing device 104 or the computing system 102 may determine importance levels for code search results in real time. In other embodiments, the determination of importance levels may be implemented offline. For example, the computing system 102 may determine importance levels for possible search queries (e.g., a keyword in code, a code snippet, etc.) beforehand, and store the importance levels, e.g., in the database 110.

The computing system 102 may be configured to utilize syntax of the source code to determine importance levels for different occurrences of a code symbol or a code snippet. The computing system 102 may also cooperate with the computing device 104 and/or another computing system (not shown in FIG. 1) to obtain code search results and/or to rank the code search results based on the determined importance levels of occurrences of the code symbol and code snippet. The computing system 102, the computing device 104 and the other computing system may be connected through one or more networks (e.g., a network 106). The computing system 102, the computing device 104, and the other computing system may exchange information using the network 106. For instance, the computing system 102 and the other computing system may be servers of the network 106 and the computing device 104 may be a node of the network 106. The computing system 102, the computing device 104 and the other computing system may communicate over the network 106 using one or more communication protocols.

In the illustrated embodiment of FIG. 1, the computing system 102 may include a retrieval module 112, a knowledge module 114, a determination module 116, a combination module 118, a ranking module 120 and/or other modules.

The retrieval module 112 may be configured to retrieve one or more representations of the syntax structure associated with source code. In various embodiments, the source code is a collection of computer instructions written using a programming language for implementing certain functionalities. For example, a source code may be written in a programming language, e.g., JAVA, PYTHON, or C++ to name a few. In some embodiments, the source code may also include comments written using a human language for annotating the computer instructions. The source code may include one or more snippets of code. The source code's collection of computer instructions may comprise one or more files, also referred to herein as source code files.

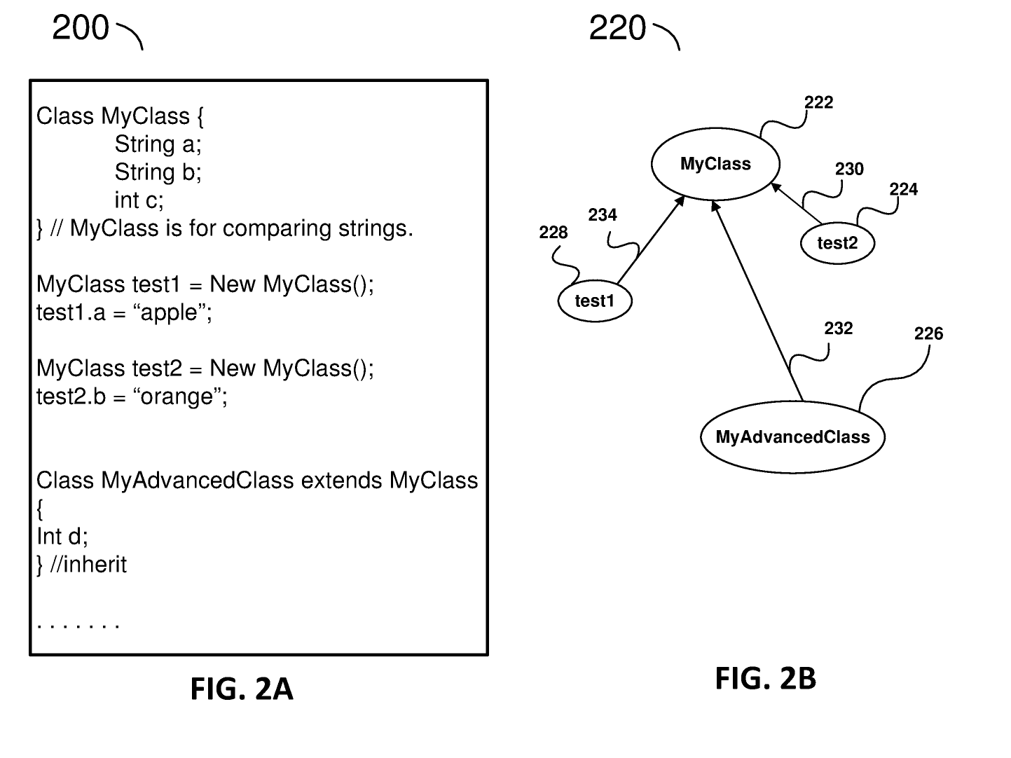

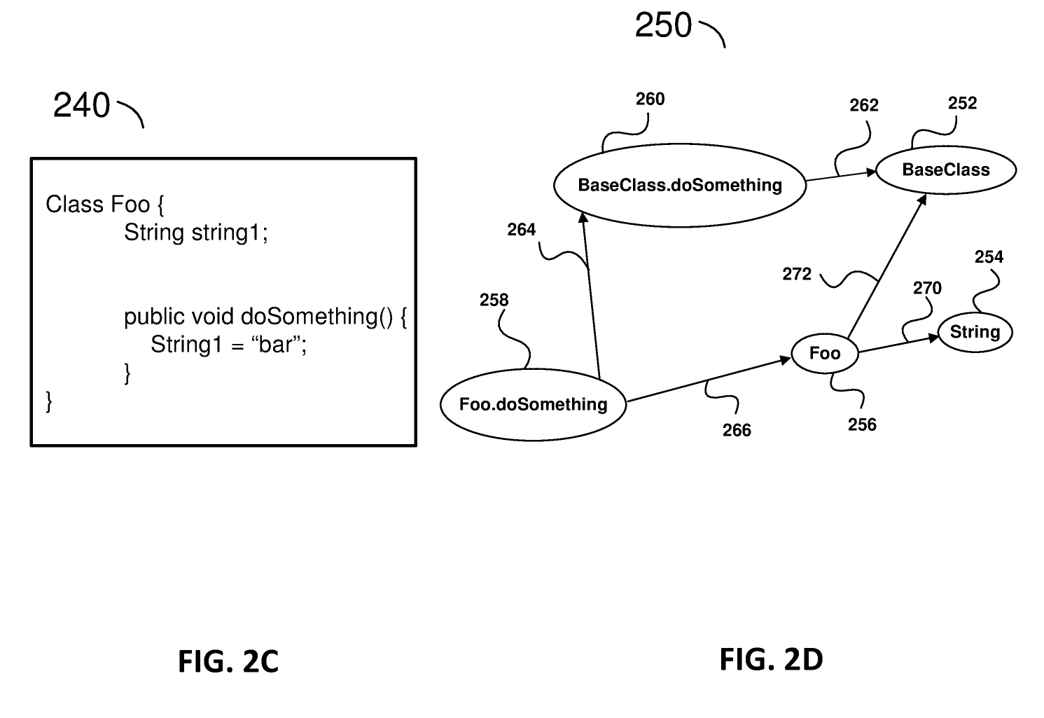

Referring to FIG. 2A, illustrated is an example of source code 200. The source code 200 may be written using JAVA programming language, for example. One skilled in the art should recognize that the source code 200 is merely an example for illustration, and other examples or other types of source code may be used by the retrieval module 112.

The retrieval module 112 in FIG. 1 may retrieve a representation of the abstract syntax structure of source code. In some embodiments, the representation may be an Abstract syntax tree (AST). The retrieval module 112 may retrieve an AST associated with a source code file by using a compiler tool. Source code written in different programming languages may be parsed or analyzed by different programming tools to generate ASTs. The retrieval module 112 may retrieve an AST of a source code file using different tools based on the programming languages writing the source code. The retrieval module 112 may store the retrieved ASTs associated with source code files into the database 110.

In some embodiments, an AST may include multiple nodes, where a node may represent a token, i.e., the smallest individual element that compilers recognize. For example, a token may be a series of continuous characters in source code that compilers treat as a separate entity. In some embodiments, a node may represent a keyword token, an identifier token, a constant token, a string token, a special symbol token, or an operator token. For example, a node may represent an identifier token, such as a class definition, a class declaration, a method usage, method declaration, a variable, etc. In the current disclosure, a token may also be referred to as “a code symbol,” “a logic symbol,” “a symbol,” hereinafter.

Referring to FIG. 2A, a node may represent a code symbol or logic symbol, such as “MyClass,” “String,” “test1,” and “test2”. In some embodiments, a node may represent an occurrence of a code symbol. For example, as illustrated in FIG. 2A, the code symbol “MyClass” occurs several times. Each occurrence of the code symbol “MyClass” may be represented by a node in the AST. For the purpose of conciseness and convenience, the term “occurrence” may be omitted when the omission will not lead to ambiguity. For example, without causing ambiguity, a node representing an occurrence of a code symbol may be referred to as a node representing a code symbol. In other embodiments, an AST may include nodes representing other types of elements in source code written in a certain programming language.

In some embodiments, an AST may also contain edges describing a relationship between nodes. For example, edges may describe a certain operation relationship between two nodes. In another example, edges may represent a “reference” relationship between two nodes. Other types of relationships may include, but are not limited to, an “override” relationship, an “inherit” relationship, an “implement” relationship, etc. For example, in an AST associated with the source code shown in FIG. 2A, the node representing the code symbol “MyAdvancedClass” and the node representing “MyClass” may have a relationship of “inherit” represented by an edge. That is, the node of “MyAdvancedClass” inherits from the node of “MyClass” in this example. Moreover, the node representing the symbol “test1” and the node representing “MyClass” may have a “reference” relationship. That is, the node of “test1” references the node of “MyClass” in this example.

In some embodiments, the retrieval module 112 may retrieve other types of syntax structures of source code that describe syntax knowledge of the source code. For example, the retrieval module 112 may retrieve a parse tree or a concrete syntax tree of source code. One skilled in the art should recognize that other types of syntax structures may also be retrieved and used.

The knowledge module 114 may be configured to generate a knowledge graph based on the one or more retrieved ASTs or other types of retrieved representations of syntax structures, which may also be referred to herein simply as retrieved syntax structures. A knowledge graph may describe relationships between code symbols or code snippets (or occurrences of code symbols or code snippets) contained in the source code. In some embodiments, the knowledge module 114 may obtain the nodes representing code symbols (or code snippets) or occurrences of code symbols (or code snippets) from an AST or another syntax structure associated with the source code. The knowledge module 114 may also obtain data describing the relationships between the nodes (e.g., the edges). The knowledge module 114 may generate a knowledge graph based on the nodes representing occurrences of code symbols (or code snippets) in the source code and the edges describing their relationships. In some embodiments, the knowledge module 114 may generate a knowledge graph by connecting the nodes based on different relationships between them. For example, the knowledge module 114 may connect a node representing a class definition and a node representing an identifier that references the class definition, and describes their referencing relationship in the knowledge graph or in other data structures.

Referring now to FIG. 2B, a block diagram for an example of a knowledge graph 220 is illustrated. In this example, the knowledge graph 220 includes nodes 222, 224, 226, 228 and their relationships represented by connection lines 230, 232, 234. The node 222 represents a code symbol “MyClass,” the node 224 represents a code symbol “test2,” and the node 226 represents a symbol “MyAdvancedClass,” and the node 228 represents a symbol “test1” in this example.

In the example in FIG. 2B, the node 222 “MyClass” is a class definition. The nodes 228, 224 “test1” and “test2” are identifiers referencing the class definition of “MyClass.” The connection line 230 may describe that the node 224 “test2” references the node 222 “MyClass.” Similarly, the connection line 234 may describe that the node 228 “test1” references the node 222 “MyClass.” Further, the connection line 232 may describe that the node 226 “MyAdvancedClass” inherits the node 222 “MyClass.” One skilled in the art should recognize that the knowledge graph 220 is merely an example for illustration, and other examples or other types of knowledge graphs may be generated by the knowledge module 114.

Referring to FIG. 2C-2D, another example of a piece of source code 240 and its corresponding knowledge graph 250 are illustrated. The knowledge graph 250 includes nodes 252, 254, 256, 258, and 260 and edges 262, 264, 266, 270, and 272 between the nodes. A node may be defined by a string signature, a location of the node, a kind of the node and a computer language used to write the code. For example, a node schema may be defined as follows:

```
struct Node { 1: string signature;
      2: File.FileLocation file_loc // location of the node
      3: MetaDataEnum.NodeKind kind
      4: File.Language lang
}.
```

In the knowledge graph 250, the node 256 may be represented as follows:

```
{“1”: “Foo”,
“2”: {
    “1”: “Iq6AhMamu2XQqE4f6Bhldg_”,
    “2”: “src/main/java/Foo.java”,
    “3”: “a6099362e89d5lf8c9934ddbf62a68f297b8d545”
  },
“3”: “Class”,
“4”: “Java”
}.
```

Optionally, the schema of a node may also include a range (e.g., a file node, a figment node, etc.), a list of modifiers (e.g., a class or method node has a list of modifiers), an identifier (e.g., the name of the symbol), a qualified name, content, a display, a version, etc.

An edge may be defined by a start node identification, an end node identification, a kind of the edge (e.g., reference, inheritance, override, implementation, etc.), a location of the edge. An example edge may be represented as the follows:

struct Edge{“1”:“Foo.doSomething”,
“2”: “Foo.string1”,
“3”: “Reference”,
“4”: {
“1”: “Iq6AhMamu2XQqE4f6Bhldg_”,
“2”: “src/main/java/Foo.java”,
“3”: “a6099362e89d51f8c9934ddbf62a68f297b8d545”}}.

Optionally, an edge structure may also include an access chain.

In the knowledge graph 250, the edge 262 points from the node 260 to the node 252, and is of the kind “reference”. Thus, the edge 262 represents a reference relationship between the node 260 and the node 252. Similarly, the edge 266 represents that the node 258 references the node 256; and the edge 270 represents that the node 256 references the node 254 in this example. The edge 264 points from the node 258 to the node 260, and represents a relationship of “override” in this example, between the nodes 258 and 260. Thus. the node 258 overrides the node 260 in this example. The edge 272 represents an “inherit” relationship between the node 256 and the node 252, where the node 256 inherits from the node 252, in this example.

In some embodiments, nodes and edges used in a knowledge graph, e.g., the nodes and edges in the knowledge graph 250, may be retrieved from different files or even different repos (projects). In fact, a knowledge graph may be constructed from all the nodes and edges that have ever been processed and stored in the database 110.

Referring back to FIG. 1, in some embodiments, the knowledge module 114 may expand the knowledge graph by incorporating more ASTs. For example, the knowledge module 114 may relate two ASTs by matching an unique node or symbol name contained in both of the trees. Assume each of two ASTs contains a node named “String,” the knowledge module 114 may merge the nodes “String” into one node so that the two ASTs are connected to form a larger knowledge graph. In other embodiments, the knowledge module 114 may not rely on the ASTs to obtain knowledge of the relationships between code symbols in source code. The knowledge module 114 may utilize other tools describing syntax structure associated with source code to analyze and obtain relation knowledge with regard to code symbols contained in source code. In some embodiments, the knowledge module 114 may not generate a graph describing the relationships between code symbols. The knowledge module 114 may use other types of data structure, e.g., a list, a tree, an array, etc., to describe the relationships between code symbols contained in source code. One skilled in the art should recognize that other types of data structures may also be used.

The determination module 116 may be configured to determine importance levels for occurrences of code symbols (or code snippets) contained in source code based on the knowledge of the relationships between the code symbols (or code snippets). In some embodiments, the determination module 116 determines the importance levels for occurrences of code symbols (or code snippets) based on the knowledge graph generated by the knowledge module 114. The importance level for an occurrence of a code symbol (or code snippets) may describe how important the occurrence of the code symbol (or code snippets) is with respect to its relationship with other occurrences of the code symbol (or code snippets) or with other code symbols (or other code snippets) contained in the source code. For example, if an occurrence of a code symbol (or code snippets) is referenced by another occurrence or another code symbol (or code snippets), then the importance level for the referenced occurrence of the code symbol (or code snippets) may be determined higher than the importance level of the other occurrence or other code symbol (or code snippets). Referring to FIG. 2B, the node 222 “MyClass” represents a class definition. The class definition “MyClass” is referenced by the identifiers “test1” 228 and “test2” 224. Therefore, the importance level for the class definition “MyClass” may be determined to be higher than those of the identifiers “test1” and “test2”, in this example.

Furthermore, the determination module 116 may use other types of relationships to determine importance levels for occurrences of code symbols (or code snippets). For example, if an occurrence of a code symbol (or code snippet) is inherited, overridden, or implemented by another occurrence or another code symbol (or code snippet), then the importance level for this occurrence of the code symbol (or code snippet) may be determined higher than the importance level of the other occurrence or code symbol (or code snippet). For example, in FIG. 2B, the class definition “MyClass” 222 is inherited by the node 226 representing another class definition “MyAdvancedClass.” Accordingly, the determination module 116 may determine an importance level for the class definition “MyClass” is higher than that of the other class definition “MyAdvancedClass” because the class “MyAdvancedClass” inherits from the class “MyClass.” One skilled in the art should appreciate that yet other types of relationships may be used to determine importance levels for occurrences of code symbols (or code snippets).

For the purpose of conciseness and convenience, a code symbol or an occurrence of a code symbol that is referenced, inherited, overridden, or implemented by other occurrences or other code symbols may be referred to as a code symbol or an occurrence of a code symbol “pointed” by the other occurrences or other code symbols, hereinafter. Alternatively, such a case may be referred to as the other occurrences or other code symbols “pointing to” the code symbol or the occurrence of the code symbol. The “pointed” or “pointing” description may also refer to other types of relationships between code symbols recognized by one skilled in the art. This can also apply for code snippets.

In some embodiments, the determination module 116 may detect the number of occurrences of a code symbol (or code snippet) or other code symbols (or other code snippets) pointing to the to-be-determined occurrence of the code symbol (or code snippet), and use the number as one factor to determine an importance level for the to-be-determined occurrence of the code symbol (or code snippet). For example, when there are more occurrences or code symbols (or code snippets) pointing to an occurrence of a code symbol (or code snippet), the determination module 116 may determine a higher importance level for that pointed occurrence of the code symbol (or code snippet). In some embodiments, an important level IL(nᵢ) for an occurrence of a code symbol (or code snippet) may be calculated by the following formula:

$$IL ( {n}_{i} ) = \frac{1 - d}{N} + d {\sum }_{{n}_{j} ∈ M ( {n}_{i} )} \frac{IL ( {n}_{j} )}{P ( {n}_{j} )} , \qquad ( 1 )$$

where n₁, n₂, . . . , n_{N} are the nodes representing occurrences of code symbols (or code snippets), e.g., the nodes in the knowledge graph; d is a damping factor which can be set between 0 and 1, e.g., 0.85 (which can vary depending on experience with the particular use); N is the total number of nodes; M(nᵢ) is the set of nodes that point to the node ni; IL(nⱼ) is the importance level of nⱼ; P(nⱼ) is the number of nodes pointed by the node n₁, where these nodes pointed by the node n, are also referred to as parent nodes of the node nⱼ.

In some embodiments, an importance level may be represented by an importance score. The determination module 116 may determine importance scores for occurrences of code symbols (or code snippets) contained in source code. For example, the determination module 116 may assign an initial importance score for each node representing a code symbol (or code snippet) or an occurrence of a code symbol (or code snippet) in a knowledge graph. The initial importance score may be one, five, 10, or 100, etc. Alternatively (for example, to prevent an overun where there are a large number of nodes), the initial importance score may be 1/n, where n is the total number of the nodes in the knowledge graph. For each node, the determination module 116 may determine whether there is any parent node pointed by the node. For example, for a node a, the parent node may be a node representing another occurrence of the code symbol (or code snippet) or another code symbol (or code snippet) pointed by the occurrence of the code symbol (or code snippet) which the node a represents. As described above, “pointed by” may describe “referenced by,” “inherited by,” “overridden by,” or “implemented by,” etc.

If there are one or more parent nodes pointed by the node, then the determination module 116 may allocate a portion of the importance score for the node to each of the one or more parent nodes pointed by the node. For example, the determination module 116 may divide the importance score for the node a into a certain number of portions based on how many parent nodes pointed by the node a, and assign each portion to each of the parent nodes. The determination module 116 may then update the importance score for the node a. For example, the determination module 116 may update the importance score by deducting the portions assigned to the parent nodes from the original importance score. The determination module 116 may move to an unvisited node in the knowledge graph and repeat the same determination and score allocation process for the next node until all nodes are visited.

In some embodiments, after the determination module 116 has traveled all the nodes in the knowledge graph and updated the importance scores for all the nodes in one iteration, the determination module 116 may implement the above-described determination and allocation process iteratively by traveling the nodes in the knowledge graph one iteration after another. Assume the importance score for a node i at an iteration j is represented by PRj(i). Then, at iteration j+1, the importance score for the node i may be updated by the following equation:

$${PR}_{j + 1} ( i ) = ( 1 - d ) + d ( \frac{{PR}_{j} ( 1 )}{C ( 1 )} + … + \frac{{PR}_{j} ( k )}{C ( k )} ) , \qquad ( 2 )$$

where d is a damping factor which can be set between 0 and 1 (e.g., set to an initial value and adjusted based on experience with a particular use); k represents the total number of nodes pointing to the node i in the knowledge graph; PRj(1) . . . PRj(k) represent the importance scores at iteration j for the nodes that point to the node i; each of C(1), . . . C(k) represents the number of outbound links from the node (1, . . . , or k) pointing to the node i (or the number of parent nodes pointed by the node (1, . . . , or k) where node i is one of the parents).

In some embodiments, the determination module 116 may recursively implement the process until the importance score for each node in the knowledge graph converges. For example, when, for each node, the determination module 116 keeps obtaining the same value of the importance score as the last iteration, or the score value stays within a predetermined small range during a number of iterations, the determination module 116 may stop the process and the importance score for each node may be determined. Referring to equation (2), the determination module 116 may continue updating the importance scores by using equation (2) until the difference between PRj(i) and PR1ⱼ₊ᵢ(i) is smaller than a predetermined threshold. On determining the difference is smaller than the predetermined threshold, the repeating process may stop changing the scores for all nodes in the knowledge graph, and the computation is converged. The importance score for the node i may be the PR_{J}(i) where J is the final iteration index.

Alternatively, importance scores S(nᵢ; t+1) for the nodes ni at iteration t+1 may be represented by the following formula:

$$S ( {n}_{i} ; t + 1 ) = \frac{1 - d}{N} + d {\sum }_{{n}_{j} ∈ M ( {n}_{i} )} \frac{S ( {n}_{j} ; t )}{P ( {n}_{j} )} , \qquad ( 3 )$$

where S(nj; t) is the importance score for the nodes nᵢ at the iteration t.

In various embodiments, the determination module 116 may assign different weights to different types of relationships when determining the importance levels of occurrences of code symbols (or code snippets). The determination module 116 may assign weights to relationships between code symbols (or code snippets) based on how important the relationships are with respect to the programming structure of the source code containing the code symbols (or code snippets). For example, the determination module 116 may assign a higher weight to a “inherit” relationship than a “reference” relationships since “inherit” is considered a stronger relationship than “reference”. In some embodiments, the determination module 116 may combine the number of occurrences of a code symbol (or code snippet) or other code symbols (or other code snippets) pointing to the to-be-determined occurrence of the code symbol (or code snippet) with the weights assigned to the relationships between them to determine an importance level for the to-be-determined occurrence of the code symbol (or code snippet). For example, the formula (1) may be redefined as:

$$IL ( {n}_{i} ) = \frac{1 - d}{N} + d \frac{1}{M} {\sum }_{{n}_{j} ∈ M ( {n}_{i} )} {w}_{{n}_{j}} \frac{IL ( {n}_{j} )}{P ( {n}_{j} )} , \qquad ( 4 )$$

where wₙⱼ is the weight assigned to the relationship between nⱼ and nᵢ; and M is the number of the set M(nᵢ).

Accordingly, formula (2) may be modified by taking the weights into consideration as follows:

$${PR}_{j + 1} ( i ) = ( 1 - d ) + d ( w ( 1 ) \frac{{PR}_{j} ( 1 )}{C ( 1 )} + … + w ( k ) \frac{{PR}_{j} ( k )}{C ( k )} ) , \qquad ( 5 )$$

where w(1) . . . w(k) are the weights assigned to the relationships between the node i and the nodes 1-k that point to the node i.

In some embodiments, the determination module 116 may store the determined importance score, e.g., in the database 110, or send the importance score to another computing system, e.g., a search engine, or a file system, or to the computing device 104 for later usage. For example, a scored node stored in the database 110 may be represented as follows:

{
1: “Foo.doSomething”
2: ”0.2”
}.

In some embodiments, the determination module 116 may also store a location associated with each occurrence of the code symbol (or code snippet) in the source code, for example, in the source code file. The determination module 116 may generate an index for lookup of code symbols (or code snippets), their locations and their importance scores. The index may be also stored in the database 110, or sent to the other computing system, or to the computing device 104.

Referring to FIG. 1, the combination module 118 may be configured to combine the importance level determined by the determination module 116 with other ranking factors to determine a combined ranking score for an occurrence of a code symbol (or code snippet). For example, the other ranking factors may include, but are not limited to, a term frequency-inverse document frequency (“tf-idf’) factor. The tf-idf factor may be determined by a module (not shown in FIG. 1) residing on the computing system 102 or another computing system. The module may determine the tf-idf factor based on certain algorithms to rank code search result based on the number of occurrences of a search query in a document. The combination module 118 may combine the importance score determined by the determination module 116 with the tf-idf factor determination by computing a weighted sum or by multiplying them to obtain a product.

In some embodiments, the combination module 118 may be configured to combine importance levels for occurrences of code symbols to obtain a combined importance level for a code snippet containing multiple code symbols or occurrences of code symbols. For example, the combination module 118 may retrieve importance scores for the occurrences of the code symbols contained in a code snippet from the index stored in the database 110. The combination module 118 may combine the retrieved importance scores to obtain a combined importance score for the code snippet. For example, the combination module 118 may add the retrieved importance scores together to obtain a sum of the importance scores. Alternatively, the combination module 118 may obtain a weighted average of the importance scores based on the locations of the code symbols or the occurrences of the code symbols, or based on other rules. In other examples, the combination module 118 may combine the importance scores by multiplying them to obtain a product. In yet other examples, the combination module 118 may combine the importance scores by using other types of measures recognized by one skilled in the art.

The ranking module 120 may be configured to rank code search results based on the importance levels for occurrences of code symbols, combined ranking scores for code symbols, or combined importance levels for code snippets. In some embodiments, when a search query is to search for a code symbol, the ranking module 120 may obtain importance scores or combined ranking scores for occurrences of the code symbol and rank the occurrences of the code symbol based on the importance scores or combined ranking scores. For example, the search query may be “string,” and assume the occurrences of the query include “java.lang.String,” and “org.lambdalab.String.” A traditional tf-idf based ranking may not be able to determine which of the two occurrences should rank higher since it does not have any knowledge about their importance to a software developer. In contrast, the ranking module 120 may rank them based on their importance scores calculated based on formula (2) or (5). For example, “java.lang.String” may have a higher score “org.lambdalab.String,” since “java.lang. String” may be pointed to (e.g., referenced, inherited, overridden, implemented) by more other occurrences. The ranking module 120 may thus rank “java.lang. String” higher than “org.lambdalab. String.”

In some embodiments, if the search query is for a code snippet, the ranking module 120 may obtain combined importance scores for occurrences of the code snippet and rank the occurrences of the code snippet based on the combined importance scores. In some embodiments, the ranking module 120 may send the ranked occurrences of the search query to the computing device 104 for providing the search results to users.

The database 110 may be any computer storage for storing the data used in the computing environment 100. The data stored in the database 110 may include, but is not limited to, source code (e.g., source code collections which may be, but is not limited to, files) containing search queries, ASTs, knowledge graphs or other data structures describing knowledge of relationships between code symbols contained in source code files, data describing importance levels for occurrences of search queries, index for lookup of code symbols, their locations and their importance scores.

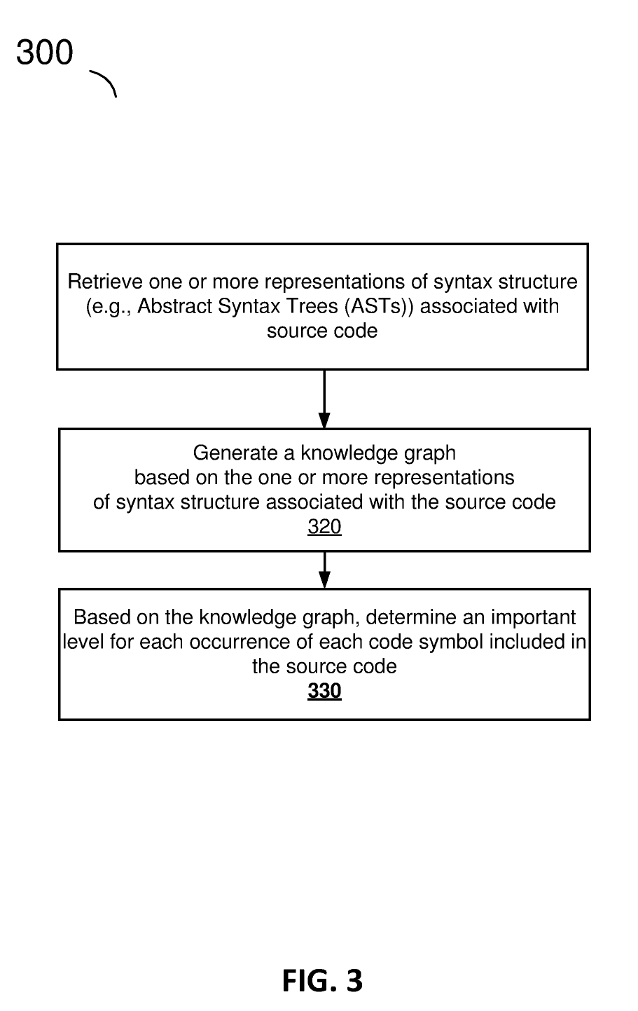

FIG. 3 illustrates a flowchart of an example method 300 for determining an importance level for an occurrence of a code symbol (or code snippet), according to various embodiments of the present disclosure. The method 300 may be implemented in various environments including, for example, the environment 100 of FIG. 1. The operations of the method 300 presented below are intended to be illustrative. Depending on the implementation, the method 300 may include additional, fewer, or alternative steps performed in various orders or in parallel. The method 300 may be implemented in various computing systems or devices including one or more processors.

In example method 300, at block 310, one or more representations of syntax structure (which may be Abstract Syntax Trees (ASTs)) associated with source code may be retrieved, where the one or more ASTs describe syntax structures of the source code. In various embodiments, the source code comprises a collection of computer instructions using a programming language, contains code symbols, may contain comments, and may comprise a collection of one or more source code files. At block 320, a knowledge graph may be generated based on the one or more representations of syntax structure (e.g., one or more ASTs), where the knowledge graph describes relationships between code symbols contained in the source code. At block 330, based on the knowledge graphs, an importance level is determined for each occurrence of each code symbol (or code snippet) contained in the source code. In various embodiments, based on the determined importance level for each occurrence, results in response to a code search query from a user are ranked for presentation to the user.

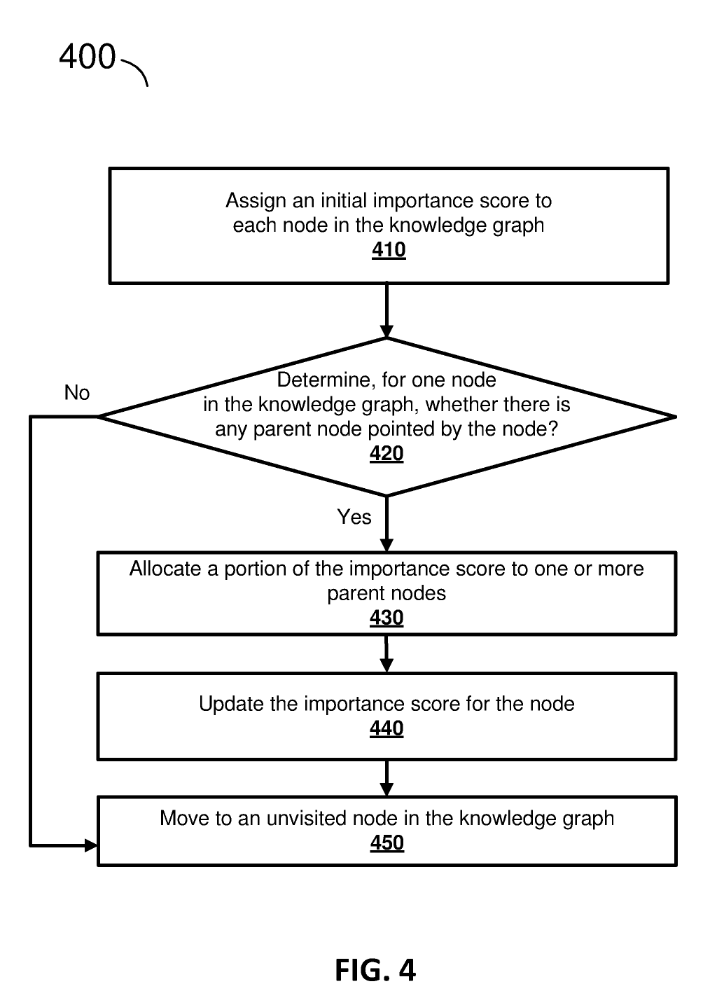

FIG. 4 illustrates a flowchart of an example method 400 for determining importance scores for nodes in a knowledge graph, according to various embodiments of the present technology. For example, the importance score may be one exemplary indicator for an importance level. The method 400 may be one exemplary method for the determination of the importance level achieved at block 330 of the method 300.

The method 400 may be implemented in various environments including, for example, the environment 100 of FIG. 1. The operations of the method 400 presented below are intended to be illustrative. Depending on the implementation, the method 400 may include additional, fewer, or alternative steps performed in various orders or in parallel. The method 400 may be implemented in various computing systems or devices including one or more processors.

For the example method 400, at block 410, an initial importance score may be assigned to each node in the knowledge graph. For example, each node in the knowledge graph may be equally assigned a predetermined initial importance score. The predetermined initial importance score may be one, five, 10, or 100, etc. Alternatively, the predetermined initial importance score may be assigned to be 1/n, (e.g., to prevent an overrun when there is a large number of nodes) where n is the total number of the nodes in the knowledge graph. In other examples, a random initial importance score may be assigned to each node in the knowledge graph. At block 420, it is determined, for one node in the knowledge graph, whether there is any parent node pointed to by the node. For example, for a node, denoted as “a,” based on the relationships described by the knowledge graph, other nodes in the knowledge graph may be checked to determine if any of them is pointed to (e.g., referenced, inherited, overridden, implemented, etc.) by the node a. If it is determined that there is one or more parent nodes pointed by the node a, then the method 400 proceeds to block 430. Otherwise, the method 400 proceeds to block 450.

At block 430, a portion of the importance score for the node may be allocated to the one or more parent nodes. For example, the importance score for the node may be divided into a certain number of portions based on the number of parent nodes pointed by it. Each portion of the score may be assigned to each parent node and therefore the importance score for each parent node may be increased by each assigned portion respectively. At block 440, the importance score for the node may be updated. For example, the portions assigned to other nodes may be subtracted from the original importance score for the node.

At block 450, the method 400 moves to an unvisited node in the knowledge graph. For example, the method 400 may randomly travel to a node that has not been visited yet in the knowledge graph during this iteration. In another example, the method 400 may travel to the next node following a predetermined order, e.g., depth-first order, breadth-first order, etc. In various embodiments, the method 400 may travel to all the nodes in the knowledge graph and implement the same operations at blocks 410-450 for each node in the knowledge graph. In some embodiments, the method 400 may run the process iteratively. For example, when finishing all the nodes in the knowledge graph in one iteration, the method 400 goes back to a first node and start the process over again. The method 400 may continue running recursively until the importance score for each node converges.

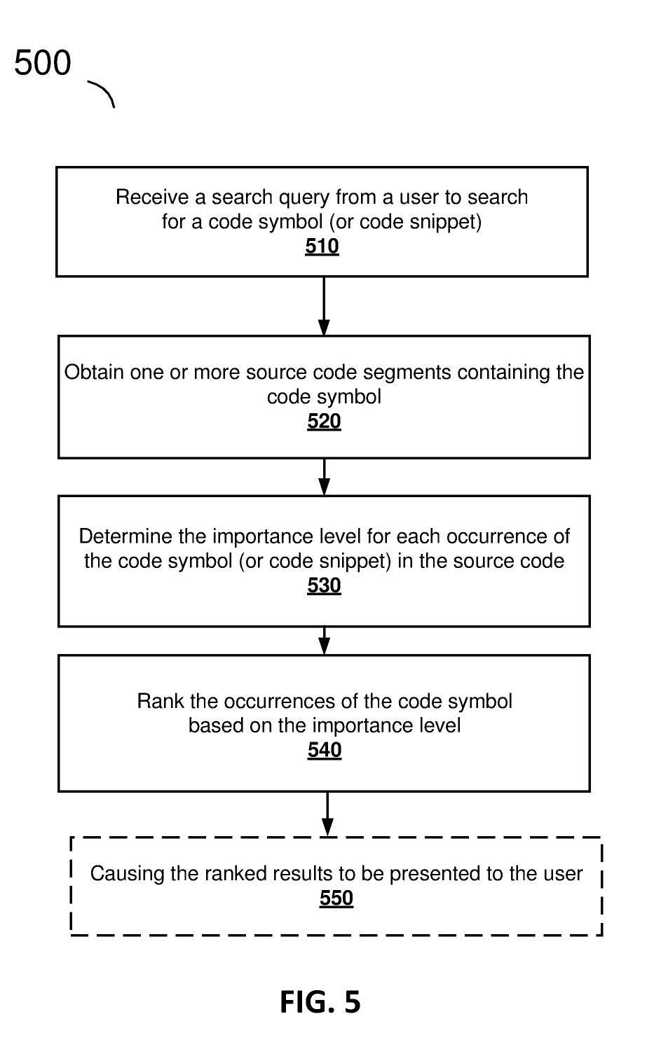

FIG. 5 illustrates a flowchart of an example method 500 for ranking occurrences of a code symbol (or code snippet), according to various embodiments of the present disclosure. The method 500 may be implemented in various environments including, for example, the environment 100 of FIG. 1. The operations of the method 500 presented below are intended to be illustrative. Depending on the implementation, the method 500 may include additional, fewer, or alternative steps performed in various orders or in parallel. The method 500 may be implemented in various computing systems or devices including one or more processors.

With respect to the method 500, at block 510, a search query may be received from a user to search for a code symbol (or code snippet). At block 520, source code containing the code symbol may be obtained. In some embodiments, the source code obtained can comprise, but is not limited to, a plurality of files. At block 530, an importance level for each occurrence of the code symbol (or code snippet) in the source code files may be determined. At block 540, the occurrences of the code symbol (or code snippet) may be ranked based on the importance level for each occurrence. The method may further include, at block 550, causing the ranked results to be presented to the user making the search query.

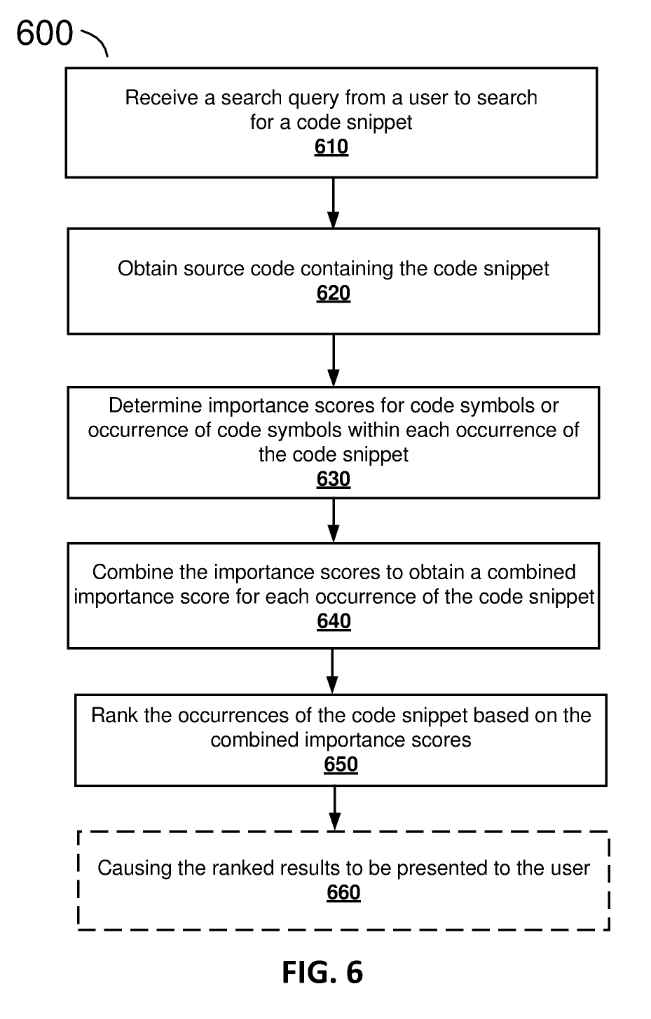

FIG. 6 illustrates a flowchart of an example method 600 for ranking occurrences of a code snippet, according to various embodiments of the present disclosure. The method 600 may be implemented in various environments including, for example, the environment 100 of FIG. 1. The operations of the method 600 presented below are intended to be illustrative. Depending on the implementation, the method 600 may include additional, fewer, or alternative steps performed in various orders or in parallel. The method 600 may be implemented in various computing systems or devices including one or more processors.

With respect to the method 600, at block 610, a search query may be received from a user to search for a code snippet. At block 620, source code containing the code snippet may be obtained. At block 630, importance scores for code symbols or occurrences of code symbols within each occurrence of the code snippet may be obtained. At block 640, the importance scores may be combined to obtain a combined importance score for each occurrence of the code snippet. At block 650, the occurrences of the code snippet may be ranked based on the combined importance scores. The method may include, at block 660, causing the ranked results to be presented to the user making the search query.

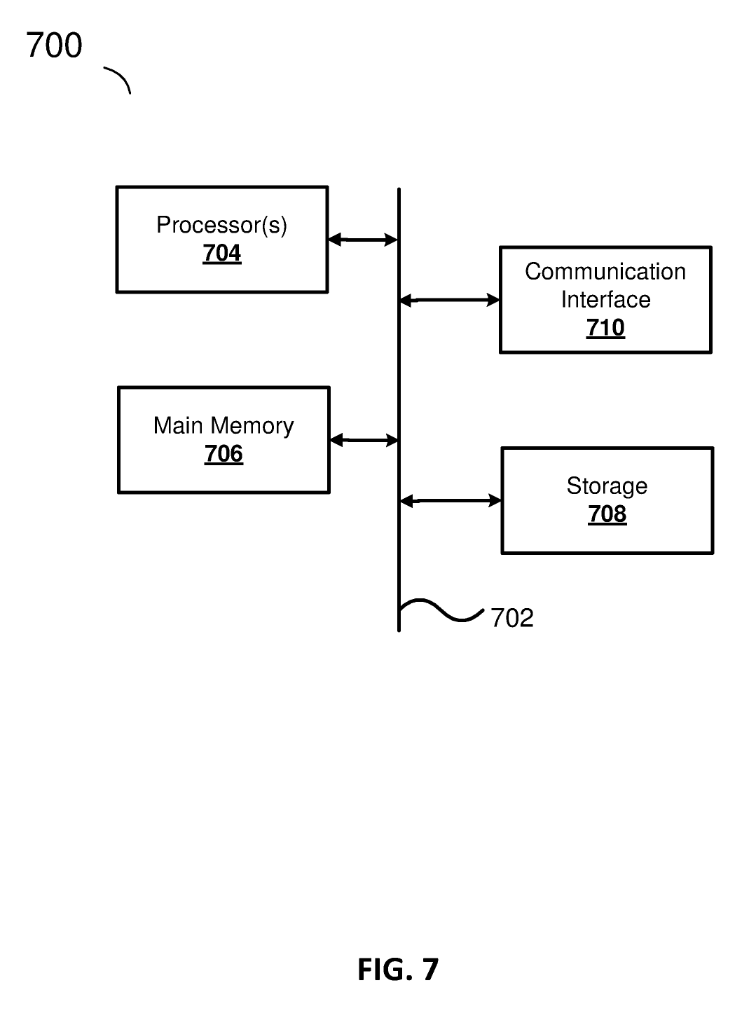

FIG. 7 is a block diagram that illustrates a computer system 700 upon which any of the embodiments described herein may be implemented. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 706, such as a random access memory (RAM), cache and/or other dynamic storage devices, coupled to bus 702 for storing information and instructions to be executed by processor(s) 704. Main memory 706 also may be used for storing temporary variables or other intermediate information during execution of instructions to be executed by processor(s) 704. Such instructions, when stored in storage media accessible to processor(s) 704, render computer system 700 into a special-purpose machine that is customized to perform the operations specified in the instructions.

The computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor(s) 704 executing one or more sequences of one or more instructions contained in main memory 706. Such instructions may be read into main memory 706 from another storage medium, such as storage device 708. Execution of the sequences of instructions contained in main memory 706 causes processor(s) 704 to perform the process steps described herein. In alternative embodiments, hard-wired circuitry may be used in place of or in combination with software instructions.

The computer system 700 also includes a communication interface 710 coupled to bus 702. Communication interface 710 provides a two-way data communication coupling to one or more network links that are connected to one or more networks. As another example, communication interface 710 may be a local area network (LAN) card to provide a data communication connection to a compatible LAN (or WAN component to communicated with a WAN). Wireless links may also be implemented.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Aspects of the present technology are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

What is claimed is:

1. A method for ranking search results based on determining an importance level for each occurrence of a code symbol contained in source code, the method implementable by a computing system, the method comprising:
retrieving one or more representations of a syntax structure associated with the source code, the representations of the syntax structure describing syntax knowledge of the source code, the source code comprising a collection of computer instructions using a programming language, the source code containing code symbols;
generating a knowledge graph based on the one or more representations of the syntax structure, the knowledge graph describing relationships between occurrences of the code symbols contained in the source code; and
based on the knowledge graph, determining an importance level for each occurrence of a code symbol contained in the source code or a code snippet contained in the source code, such that, based on the importance level for each occurrence, results in response to a code search query from a user are ranked for presentation to the user.

2. The method of claim 1, wherein the one or more representations of the syntax structure of the source code are Abstract Syntax Trees (ASTs).

3. The method of claim 1, wherein the source code comprises a collection of one or more source code files, the source code including one or more of the code symbols.

4. The method of claim 1, wherein the importance level, for each occurrence of the code symbol or the code snippet, describes how important each occurrence is:
with respect to each occurrence's relationship with other occurrences of the code symbol or the code snippet contained in the source code, or
with respect to each occurrence's relationship with other code symbols or other code snippets contained in the source code.

5. The method of claim 2, wherein generating a knowledge graph based on the one or more ASTs comprises relating two of the one or more ASTs by matching a unique node name contained in the two of the one or more ASTs.

6. The method of claim 2, wherein generating a knowledge graph based on the one or more ASTs comprises:
obtaining a plurality of nodes from the one or more ASTs, the nodes representing the occurrences of the code symbols or the code snippets contained in the source code;
obtaining data describing the relationships between the plurality of nodes from the one or more ASTs; and
generating the knowledge graph using the plurality of nodes and the data describing the relationships between the plurality of nodes.

7. The method of claim 6, wherein determining an importance level for each occurrence of the code symbol or the code snippet comprises:
assigning an initial importance score to each node in the knowledge graph; and
updating the initial importance score for each node.

8. The method of claim 7, wherein the updating of the initial importance score is performed recursively until a converged importance score is determined.

9. The method of claim 8, wherein the updating of the initial importance score comprises:
determining, for each node in the knowledge graph, that there are one or more parent node pointed to by the node;
allocating a portion of the initial importance score to each of the one or more parent nodes; and
updating the initial importance score for the node by deducting from the initial importance score the one or more portions of the initial importance score allocated to the one or more parent nodes.

10. The method of claim 9, wherein the one or more parent nodes represent occurrences of the code symbols that are referenced, inherited, overridden, or implemented by the occurrence of the code symbol that the first node represents.

11. The method of claim 1, wherein the importance level is represented by an importance score, and wherein the method further comprises combining the importance score with a term frequency-inverse document frequency (tf-idf) ranking factor to obtain a combined ranking score.

12. The method of claim 1, further comprising:
determining importance levels for each of the occurrences of the code symbols contained in the source code; and
generating an index for lookup of the occurrences of the code symbols, locations of the occurrences of the code symbols in the source code, and the importance levels for the occurrences of the code symbols.

13. The method of claim 1, wherein the importance level is represented by an importance score, and wherein determining the importance level for the code snippet, the code snippet containing a plurality of occurrences of code symbols, comprises:
determining importance scores for the plurality of occurrences of code symbols; and
combining the importance scores for the plurality of occurrences of code symbols.

14. The method of claim 1, further comprising storing the determined importance levels in a database.

15. The method of claim 14, further comprising:
in response to receiving a search query from a user to search for a code symbol in the source code, determining that the importance levels associated with the search query have been pre-determined and stored in a database; and
determining the importance levels by retrieving the importance levels from the database.

16. A method for ranking code search results, the method implementable by a computing system, the method comprising:
in response to receiving a search query from a user to search for a code symbol or a code snippet in source code:
determining whether the importance levels associated with the search query have already been determined for the source code;
if the importance levels associated with the search query have already been determined for the source code:
retrieving the already determined importance levels;
obtaining importance scores represented by the already determined importance levels; and
ranking the occurrences of the code symbol based on the importance scores.
if the importance levels associated with the search query have not been already been determined, determining the importance levels in real time.

17. The method of claim 16, wherein determining the importance levels comprises:
retrieving one or more Abstract Syntax Trees (ASTs) associated with the source code, the ASTs describing syntax knowledge of the source code, the source code comprising a collection of computer instructions using a programming language, the source code further comprising code symbols;
generating a knowledge graph based on the one or more ASTs, the knowledge graph describing relationships between occurrences of the code symbols contained in the source code; and
based on the knowledge graph, determining an importance level for each occurrence of a code symbol contained in the source code contained in the source code.

18. The method of claim 17, wherein the search query from the user is to search for a code snippet in the source code, the method further comprising:
determining importance scores for occurrences of the code symbols within each occurrence of the code snippet;
combining the importance scores for the occurrences of the code symbols within each occurrence of the code snippet to obtain a combined importance score for the each occurrence of the code snippet; and
ranking the occurrences of the code snippet based on the combined importance score for the each occurrence of the code snippet.

19. The method of claim 18, wherein determining importance scores comprises retrieving the importance scores for occurrences of the code symbols from a database.

20. A system for ranking code search results, the system comprising:
one or more processors; and a
memory storing instructions that, when executed by the one or more processors, cause the system to perform:
receiving a search query from a user to search for a code symbol or a code snippet;
obtaining source code containing occurrences of the code symbol or the code snippet;
determining importance scores for occurrences of the code symbol or the code snippet contained in the source code;
ranking the occurrences of the code symbol or the code snippet based on the importance scores, for providing to a user in response to the code search query; and
causing the ranked occurrence of the code symbols or the code snippets to be presented to a user.
